(19) United States
(12) Patent Application Publication
(10) Pub. No.: US 2004/0084260 A1
(43) Pub. Date: May 6, 2004

(54) Integrated brake rotor

(75) Inventors: David S. Hoyte, Sheboygan, WI (US); Alan Honggen Jiang, Sheboygan Falls, WI (US); Kwok-Sang Chui, Columbus, IN (US)

Correspondence Address: MICHAEL BEST & FRIEDRICH, LLP, 100 E WISCONSIN AVENUE, MILWAUKEE, WI, 53202, US

(73) Assignee: J. L. French Automotive Castings, Inc., Sheboygan, WI (US)

(21) Appl. No.: 10/286,553

(22) Filed: Nov. 1, 2002

(51) Int. Cl. F16D 65/12

(52) U.S. Cl. 188/218 XL

(57) ABSTRACT

A brake rotor having a rotor body made of a first material. The rotor body includes a disc portion with an inner disc surface and outer disc surface. An inner braking ring made of a second material is positioned on the inner disc surface. The inner braking ring includes at least one projection engaging the rotor body to help prevent the inner braking ring from separating from the inner disc surface. The brake rotor also includes an outer braking ring made of the second material that is positioned on the outer disc surface. The outer braking ring includes at least one projection engaging the rotor body to help prevent the outer braking ring from separating from the outer disc surface.

### BACKGROUND OF THE INVENTION

This invention relates generally to braking components, and more particularly to brake rotors.

Brake rotors are integral components of disc brake systems used in overland vehicles. Generally, brake rotors include a braking surface that is frictionally engaged by calipers having brake pads to slow or stop rotation of the brake rotors. The size and weight of the brake rotors are highly variable. The brake rotors must be designed to provide adequate braking forces to the vehicle when the vehicle is fully loaded. In addition, brake rotors must be designed with an acceptable service life. A passenger vehicle, for example, typically utilizes relatively large and heavy brake rotors to provide the braking forces typically required by a large, heavy vehicle. The large and heavy brake rotors also typically provide the passenger vehicle with a long service life before replacement is required.

To provide adequate service life, brake rotors, in general, are typically cast from a cast iron material, which has adequate hardness and wear resistance properties. However, cast iron has a relatively high material density compared to other materials and a relatively low thermal conductivity, meaning the cast iron brake rotors are often unnecessarily heavy, and can not dissipate heat as efficiently as other materials. One problem associated with poor heat dissipation is that heat build-up in the brake rotors can lead to decreased braking performance.

From an energy standpoint, a relatively large amount of energy is required to accelerate the large, heavy, cast iron brake rotors that are typically found in passenger vehicles. Also, relatively large braking forces are required to decelerate such rotors. The weight of the rotors also negatively impacts fuel economy.

Prior attempts have been made to address some of these problems. One attempt provided a brake rotor having braking rings fastened to the rotor body. The braking rings were fastened using ordinary fasteners, such as bolts or screws, or riveted to the rotor body using ordinary rivets. However, these brake rotors are not completely satisfactory. The connection between the rotor body and the braking rings may loosen after repeated loading and unloading cycles. Further, the parts must be joined together using a manual or relatively-complex, automated process.

### SUMMARY OF THE INVENTION

Accordingly, there is a need for an improved brake rotor having parts that are not fastened using typical fasteners. In one embodiment, the invention provides an integrated brake rotor. In one form, the integrated brake rotor includes a rotor body made of a first material. The rotor body has a disc portion with an inner disc surface, an outer disc surface, and an inner braking ring made of a second material and positioned on the inner disc surface. The inner braking ring includes at least one projection engaging the rotor body to help maintain the inner braking ring in a fixed orientation relative to the inner disc surface, and an outer braking ring made of the second material and positioned on the outer disc surface. The outer braking ring includes at least one projection engaging the rotor body to help maintain the outer braking ring in a fixed orientation relative to the outer disc surface. In some embodiments, the rotor body is made from a relatively low-density material, like aluminum alloy, and the braking rings are made from a higher-density (and harder) material, like steel or titanium. These materials may be advantageously used together to construct an integrated brake rotor that utilizes the superior properties of both aluminum alloy and steel (or titanium).

In another embodiment, the invention provides a brake rotor including a rotor body made of a first material. The rotor body includes a disc portion having an inner disc surface and outer disc surface, a central hub portion coupled to the disc portion, and a projection extending from the central hub portion. The brake rotor also includes an inner braking ring made of a second material and positioned on the inner disc surface, the inner braking ring having a recess engaging the projection of the rotor body to maintain the inner braking ring in a fixed orientation relative to the inner disc surface. The brake rotor further including an outer braking ring made of the second material and positioned on the outer disc surface, the outer braking ring having a recess engaging the projection of the rotor body to maintain the outer braking ring in a fixed orientation relative to the outer disc surface.

In another embodiment, the invention provides a method of manufacturing a brake rotor, the method includes positioning a first braking ring having a first projection extending therefrom within a die, positioning a second braking ring having a second projection extending therefrom within the die and in facing relationship with the first braking ring, filling the die with a molten metal, guiding the molten metal to at least partially engulf the first and second projections, cooling the molten metal, and removing the brake rotor from the die.

One advantage of embodiments of the integrated brake rotor is that it is more lightweight when compared to a cast iron brake rotor of a similar size. As a result, less energy is required to accelerate (rotationally) the brake rotor, which among other benefits, improves fuel mileage for the associated vehicle. Another advantage is that the rotor is assembled without the need to secure bolts, screws, or other fasteners to parts of the rotor.

Further objects and advantages of the present invention, together with the organization and manner of operation thereof, will become apparent from the following detailed description of the invention when taken in conjunction with the accompanying drawings, wherein like elements have like numerals throughout the drawings.

### BRIEF DESCRIPTION OF THE DRAWINGS

In the drawings:

FIG. 1 is a perspective view of a brake rotor constructed in accordance with one embodiment of the invention.

FIG. 2A is a perspective view of an outer braking ring of the brake rotor of FIG. 1.

FIG. 2B is a perspective view of an inner braking ring of the brake rotor of FIG. 1.

FIG. 3 is a cross-sectional view of the brake rotor of FIG. 1 taken along section 3-3.

FIG. 4 is a perspective view of a brake rotor constructed in accordance with another embodiment of the invention.

FIGS. 5A-5B illustrate a die casting method of manufacturing the brake rotor of FIG. 1.

FIG. 6 is a perspective view of a brake rotor constructed in accordance with yet another embodiment of the invention.

FIG. 7 is a cross-sectional view of the brake rotor of FIG. 6 taken along section 7-7.

### DETAILED DESCRIPTION

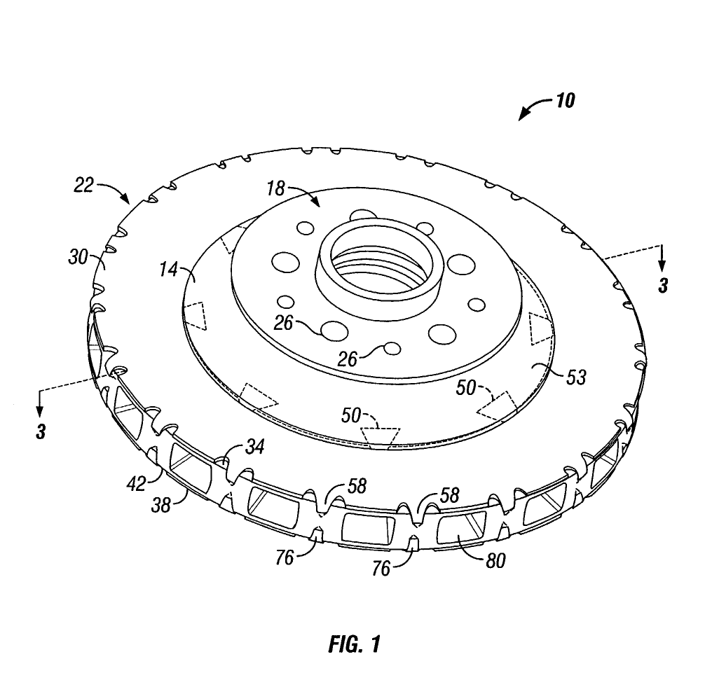

With reference to FIG. 1, an exemplary integrated brake rotor 10 is shown. Generally, the brake rotor 10 includes a rotor body 14 having a hub portion 18 and a disc portion 22. The brake rotor 10 mounts to a vehicle's spindle (not shown) via the hub portion 18. The hub portion 18 further includes spaced apertures 26 therethrough to affix wheel studs (not shown). Alternatively, if the brake rotor 10 is driven, the wheel studs may be affixed to an axle or constant velocity (“C-V”) joint, and the hub portion 18 may be inserted upon the axle or C-V joint such that the wheel studs protrude through the spaced apertures 26.

As shown in FIG. 1, an outer braking ring 30 is coupled to the rotor body 14 on one side of disc portion 22, and positioned on an outer disc surface 34 of the rotor body 14. An inner braking ring 38 is coupled to the rotor body 14 on the other side of the disc portion 22, and positioned on an inner disc surface 42. The outer and inner braking rings 30, 38 are coupled to the rotor body 14 such that the outer braking ring 30 faces away from the spindle, while the inner braking ring 38 faces toward the spindle. The braking rings 30, 38 provide braking surfaces that are frictionally engaged by a caliper through brake pads (not shown), rather than the brake pads frictionally engaging the outer and inner disc surfaces 34, 42 of the rotor body 14 itself.

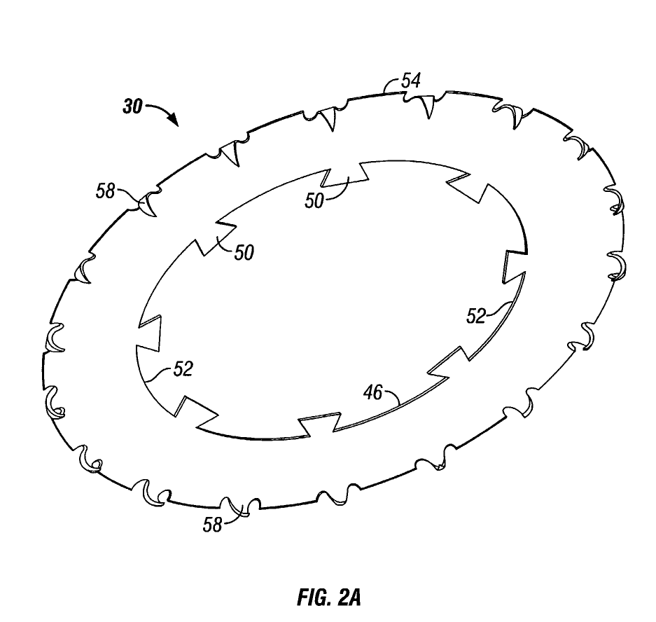

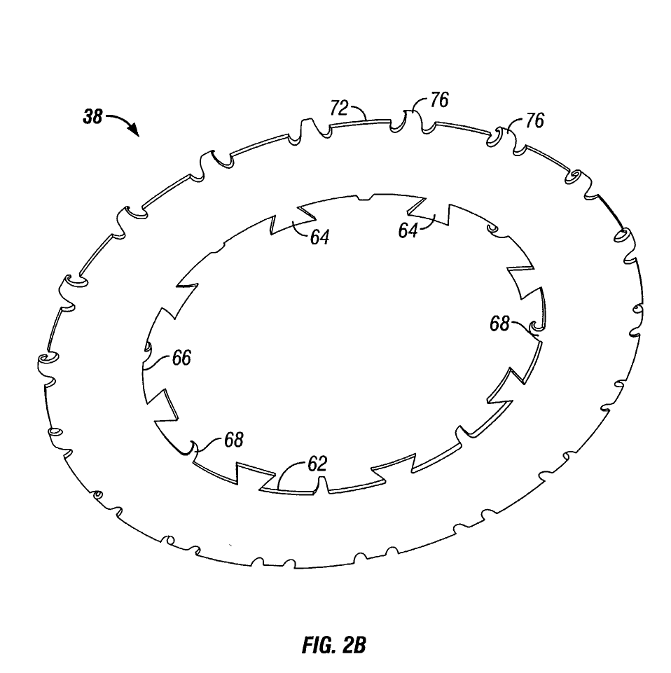

The outer and inner braking rings 30, 38 are shown separated from the rotor body 14 in FIGS. 2A-2B, respectively. As shown in FIG. 2A, the outer braking ring 30 includes an inner perimeter surface 46 having means for securing the outer braking ring 30 to the rotor body 14 in the form of a plurality of teeth 50 extending radially therefrom that engage the rotor body 14 to help prevent the outer braking ring 30 from separating from the outer disc surface 34 of the rotor body 14. The teeth 50 are shown as having a dove-tail shape. However, the teeth 50 may be formed or otherwise constructed in a number of different shapes. Some of those shapes may include, among others, square, triangular, rectangular, trapezoidal, circular, elliptical, T-shaped, oblong, symmetrical, and asymmetrical shapes, to name a few. Similarly, the teeth 50 may extend radially inward, thereby creating a void, or recess 52, in the inner perimeter surface 46 of the outer braking ring 30 to engage a projection 53 on the rotor body 14. The recesses 52 may take similar shapes as those previously stated. As a further alternative, only one or two teeth 50 may be used on the inner perimeter surface 46, rather than the multiplicity of teeth 50 shown in FIGS. 2A-2B.

In embodiments shown, the outer braking ring 30 also includes an outer perimeter surface 54 having means for securing the outer braking ring 30 to the rotor body 14 in the form of a plurality of hooks 58 extending therefrom that engage the rotor body 14 to help prevent the outer braking ring 30 from separating from the outer disc surface 34 of the rotor body 14. The hooks 58 include a curved profile and a tapered shape, such that the hooks 58 terminate at a point. Like the teeth 50, the hooks 58 may be shaped in a large number of different ways. Generally, the hooks 58 may include any reasonably shaped projection, where the projection extends from the outer braking ring 30, and is engageable with the rotor body 14.

As shown in FIG. 2B, the inner braking ring 38 is similar to the outer braking ring 30. The inner braking ring 38 includes an inner perimeter surface 62 having means for securing the inner braking ring 38 to the rotor body 14 in the form of a plurality of teeth 64 extending radially therefrom that engage the rotor body 14 to help prevent the inner braking ring 38 from separating from the inner disc surface 42 of the rotor body 14. Like the teeth 50 of the outer braking ring 30, the teeth 64 are shown as having a dove-tail shape. However, the teeth 64 may take a number of alternative forms or shapes such as those described above for the teeth 50 of the outer braking ring 30. Similarly, the teeth 64 may extend radially inward, thereby creating a void, or recess 66, in the inner perimeter surface 62 of the inner braking ring 38 to engage the projection 53 of the rotor body 14. The recesses 66 may take similar shapes as those previously stated. As a further alternative, only one or two teeth 64 may be used on the inner perimeter surface 62, rather than a multiplicity of teeth 64. As yet another alternative, the teeth 64 of the inner braking ring 38 may have a different shape than the teeth 50 of the outer braking ring 30.

In addition to the teeth 64, the inner braking ring 38 includes means for securing the inner braking ring 38 to the rotor body 14 in the form of a plurality of hooks 68 extend from the inner perimeter surface 62 to engage the rotor body 14. The hooks 68 may be similar to the hooks 58 of the outer braking ring 30, both in profile and shape. The hooks 68 supplement the teeth 64 on the inner perimeter surface 62, such that the hooks 68 and teeth 64 work in combination to help prevent the inner braking ring 38 from separating from the inner disc surface 42 of the rotor body 14. Alternatively, the hooks 68 may be different from the hooks 58 of the outer braking ring 30, while still helping to prevent the inner braking ring 38 from separating from the inner disc surface 42.

The inner braking ring 38 further includes an outer perimeter surface 72 having means for securing the inner braking ring 38 to the rotor body 14 in the form of a plurality of hooks 76 extending therefrom to engage the rotor body 14 to help prevent the inner braking ring 38 from separating from the inner disc surface 42 of the rotor body 14. The hooks 76 may be similar to the hooks 68 extending from the inner perimeter surface 62, both in profile and in shape. Like the teeth 64, the hooks 76 may alternatively include a large number of different shapes. Generally, the hooks 76 may include any reasonably shaped and configured projection, where the projection extends from the inner braking ring 38, and is engageable with the rotor body 14.

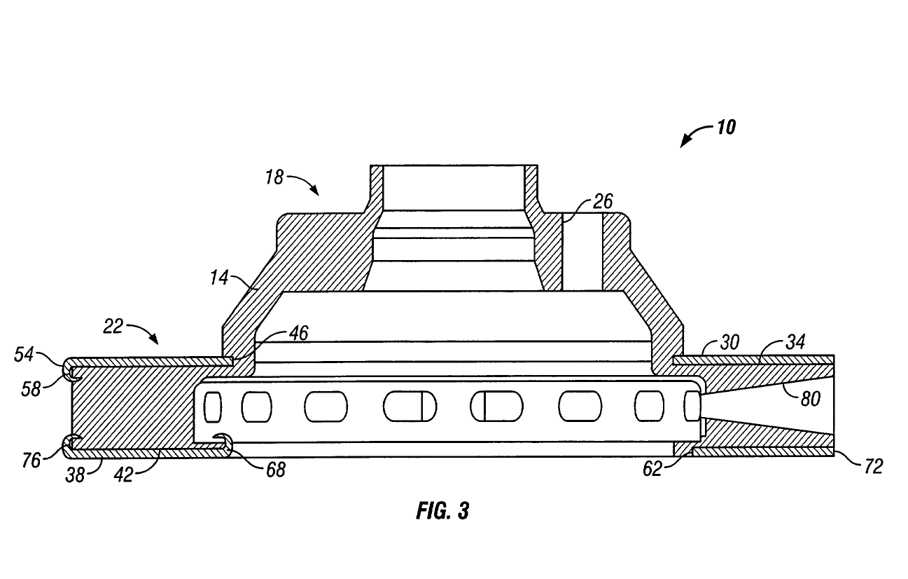

As shown in FIGS. 1 and 3, a plurality of cooling passages 80 are formed into the rotor body 14. The cooling passages 80 include channels that are straight and extend radially outward from the interior of the rotor body 14 to allow air to pass therethrough for convective cooling of the brake rotor 10. Each cooling passage 80 generally includes a rectangular section, wherein the section varies in size along the length of the cooling passage 80.

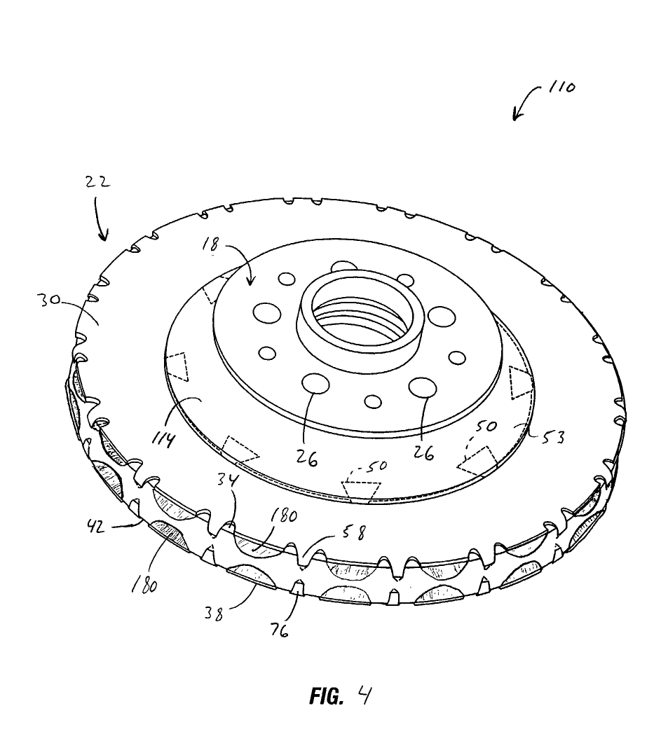

Another construction of an integrated brake rotor 110 is shown in FIG. 4. A plurality of cooling passages 180 are formed into the rotor body 114. The cooling passages 180 include opposing, semi-circular channels that are straight and extend radially outward from the interior of the rotor body 114. The section of the semi-circular channels varies in size along the length of the cooling passage 180. Like the cooling passages 80 of the rotor body 14, the cooling passages 180 allow air to pass therethrough for convective cooling of the brake rotor 110.

Alternatively, the cooling passages 80, 180 may be curved, such that cooling characteristics of the brake rotor 10, 110 may be changed. Also, the section of the cooling passages 80, 180 may include any reasonable shape, such as, for example, circular, elliptical, square, trapezoidal, oblong, and so forth.

The brake rotors 10, 110 dissipates heat more efficiently than a cast iron brake rotor for a number of reasons. One of those reasons includes the desirable material properties of aluminum alloy. The thermal conductivity of aluminum alloy is about three times greater than cast iron, and the thermal diffusivity of aluminum alloy is about four times greater than cast iron. Both of these material properties relate how well a material is able to conduct heat. As a result, the integrated brake rotor 10, 110 (having the aluminum alloy rotor body 14, 114) is able to dissipate the built-up heat at a higher rate than the cast iron brake rotor. Further, the integrated brake rotor 10, 110 is capable of providing increased braking performance over a period of use, when compared to a cast iron brake rotor.

Preferably, the outer and inner braking rings 30, 38 are stamped from sheet metal, such as steel or titanium. The teeth 50, 64 and hooks 58, 68, 76 are also formed during the stamping process, which can be achieved using conventional methods and technologies such as stamping dies and stamping presses. Stamping the braking rings 30, 38 provides a product that requires little, if any, additional machining to achieve a final product. Further, the stamping dies are re-usable. Thus, stamping the braking rings 30, 38 from sheet metal is highly economical and productive. Alternatively, the braking rings 30, 38 may be cast and/or machined, rather than stamped from sheet metal. Generally, the braking rings 30, 38 may be made of any metal harder and with a higher melting temperature than the cast aluminum alloy rotor body 14.

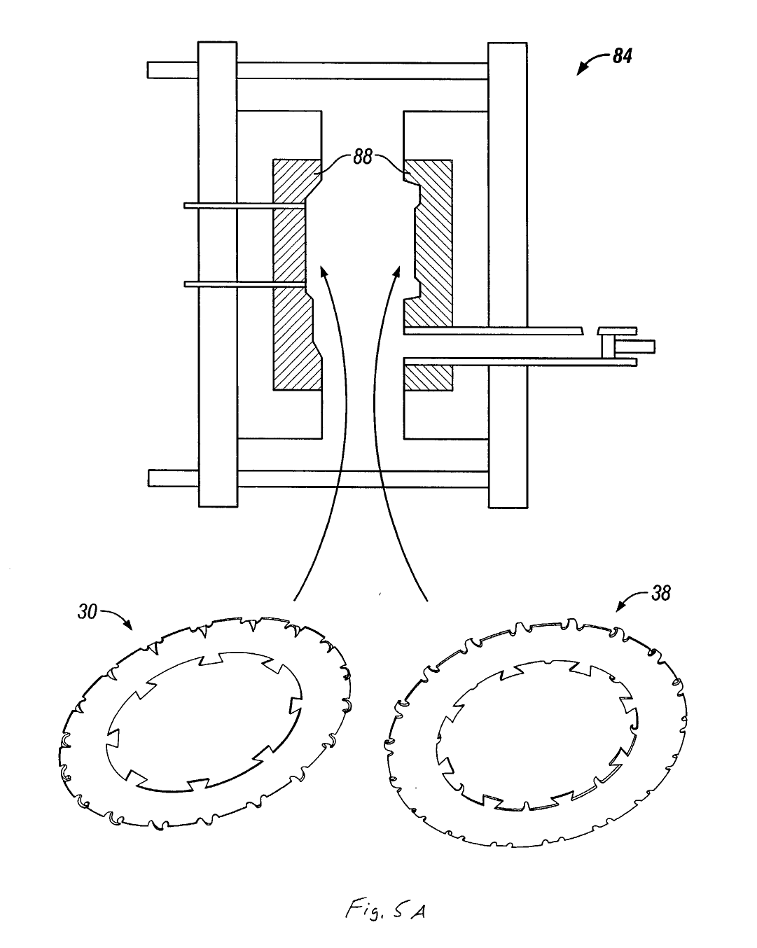

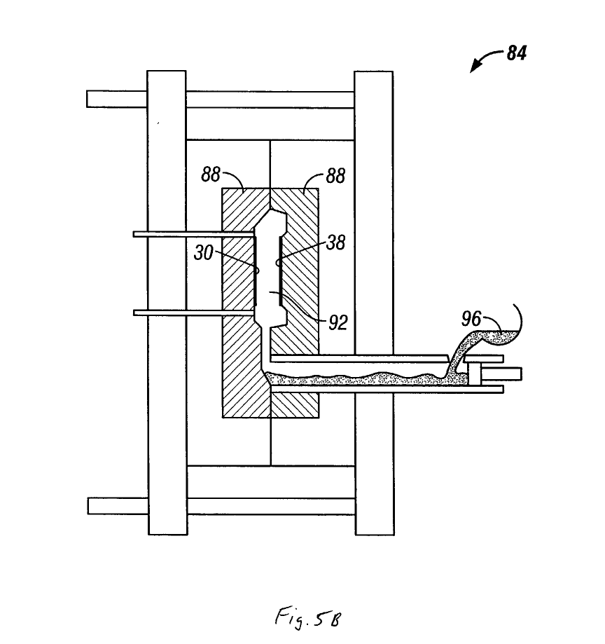

An integrated brake rotor 10 constructed in accordance with teachings of the invention may be manufactured in a number of ways. However, for purposes of illustration only, the integrated brake rotor 10 is shown being manufactured using high-pressure die casting. FIGS. 5A-5B illustrate a typical high-pressure die casting technique 84 that may be used to manufacture exemplary integrated brake rotors 10. FIG. 5A illustrates two separated die halves 88. The outer braking ring 30 is positioned within one die halve 88, and the inner braking ring 38 is positioned within the other die halve 88. The braking rings 30, 38 are positioned in the die halves 88 such that the hooks 58, 68, 76 of the braking rings 30, 38 project away from the respective die halves 88. As shown in FIG. 5B, the die halves 88 are joined to form a die cavity 92, and a shot 96 of aluminum alloy is injected into the die cavity 92 by the die casting machine. The shot 96 of aluminum alloy, or molten aluminum alloy, conforms with the die into the shape of the rotor body 14. Since the braking rings 30, 38 are made of a material, such as steel or titanium, that has a higher melting temperature than the aluminum alloy, the braking rings 30, 38 maintain their shape upon contact with the molten aluminum alloy. The hooks 58, 68, 76 and teeth 50, 64 are engulfed by the molten aluminum alloy such that when the molten rotor body 14 cools, the hooks 58, 68, 76 and teeth 50, 64 become engaged with the rotor body 14. After cooling, the integrated brake rotor 10 is removed from the die halves 88 in a manner similar to that used for other die cast components.

The hooks 58, 68, 76 and teeth 50, 64 help prevent the braking rings 30, 38 from rotating relative to the rotor body 14 and pulling away from the rotor body 14. The compression force applied by the caliper to the braking rings 30, 38 occurs in a direction substantially perpendicular to the surface of the braking rings 30, 38. However, the braking force resulting from the compression force is applied substantially in plane with the braking rings 30, 38. During its service life, the integrated brake rotor 10 will be repeatedly loaded and unloaded. Since the rotor body 14 is cast around the hooks 58, 68, 76 and teeth 50, 64, the hooks 58, 68, 76 and teeth 50, 64 engage the rotor body 14. The braking rings 30, 38 generally remain associated with the rotor body 14 such that the rotor body 14 and the braking rings 30, 38 do not separate (due to repeated loading/unloading cycles).

The high-pressure die casting technique 84 illustrated in FIGS. 5A-5B is useful when a high-volume production, low per-unit cost is desired. However, if a more low-volume production is desired, several other casting techniques exist that can produce the integrated brake rotor 10 as described above. Some of those casting techniques include low-pressure die casting, gravity die casting, and sand casting, among others, which are all conventional casting techniques and are known to one of ordinary skill in the art.

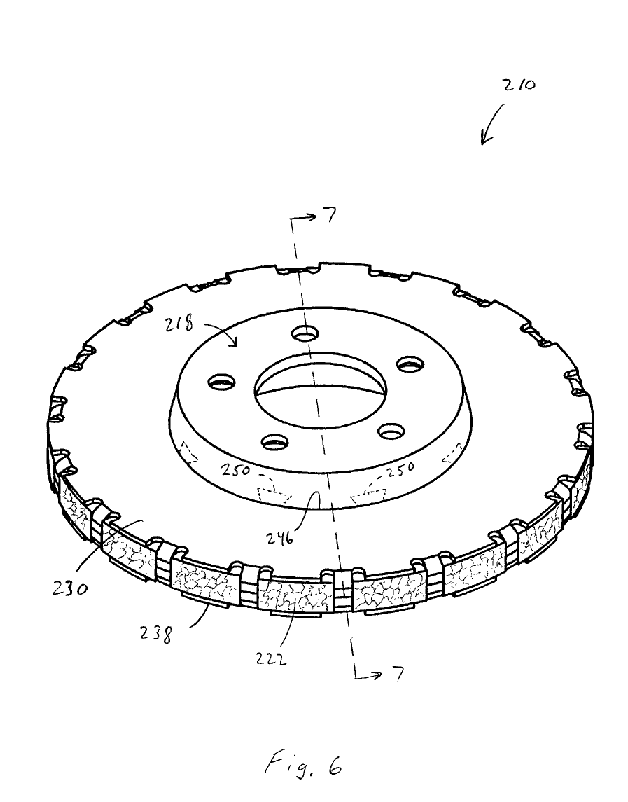

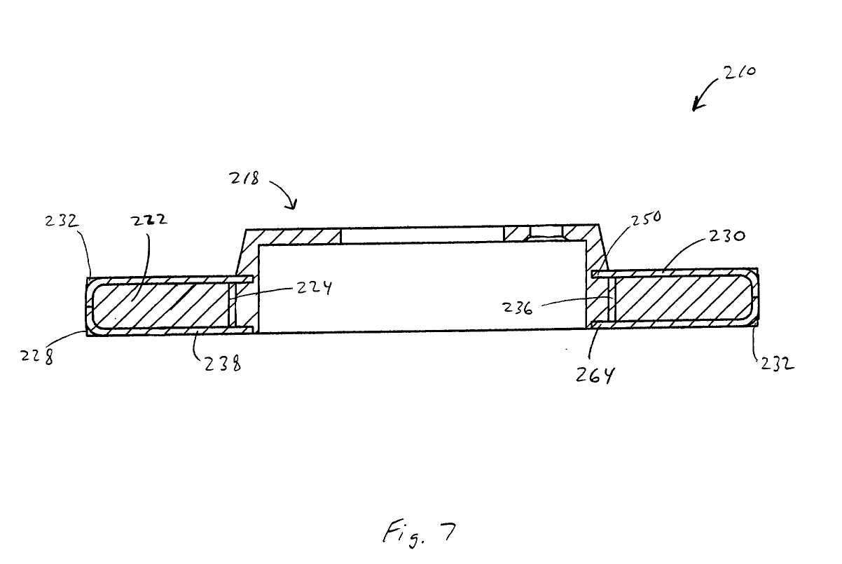

Another construction of an integrated brake rotor 210 is shown in FIGS. 6-7. As shown in FIGS. 6-7, a disc portion ring 222 is pre-cast of a porous material, such as, for example, aluminum foam. The disc portion ring 222 includes an inner perimeter surface 224 and an outer perimeter surface 228. The outer perimeter surface 228 includes a plurality of notches 232 therein. The notches 232 are formed with the casting of the disc portion ring 222, but alternatively may be machined after casting. A spacer ring 236 is positioned inside the disc portion ring 222, such that the spacer ring 236 fits snugly with the inner perimeter surface 224 of the disc portion ring 222. The spacer ring 236 is made of steel, but alternatively may be made of any material having a higher melting point than the aluminum disc portion ring 222, such as titanium, for example. An inner braking ring 238 and an outer braking ring 230 are positioned on opposite sides of the disc portion ring 222 such that hooks 258, 276 of the outer braking ring 230 and inner braking ring 238, respectively, engage the notches 232 of the disc portion ring 222. Like the braking rings 30, 38, the outer and inner braking rings 230, 238 include a plurality of teeth 250, 264, respectively, around the inner perimeter surface 246 of the outer braking ring 230 and the inner perimeter surface (not shown) of the inner braking ring 238. The teeth 250, 264 engage the central hub portion 218 to help prevent the outer and inner braking rings 230, 238 from separating from the disc portion ring 222 of the brake rotor 210. Like the teeth 50, 64, the teeth 250, 264 may also take a large number of different shapes and/or forms rather than the dove-tail shape shown in FIG. 6.

Similar to the brake rotor 10, the brake rotor 210 may also be manufactured in a number of ways, including high-pressure die casting. The method shown in FIGS. 5A-5B is generally consistent with the method used to manufacture the brake rotor 210. The disc portion ring 222, spacer ring 236, and the outer and inner braking rings 230, 238 are preassembled into a rotor subassembly before entering the die cavity 92. Once the rotor subassembly is in the die cavity 92, a shot 96 of aluminum alloy, or molten aluminum is injected into the die cavity 92. The die cavity 92 is shaped to cast a central hub portion 218 generally inside and around the rotor subassembly.

As shown in FIGS. 6-7, the teeth 250, 264 of the outer and inner braking rings 230, 238 are engulfed by the molten aluminum as the central hub portion 218 is cast, such that the teeth 250, 264 engage the central hub portion 218 upon cooling of the brake rotor 210. During the die casting process, the spacer ring 236 provides a barrier from the molten aluminum from contacting the disc portion ring 222, which is made of aluminum foam. If the molten aluminum were allowed to contact the disc portion ring 222, the ring 222 could possibly soften or melt. The process occurs at such a rate that heat from the molten aluminum does not conduct through the spacer ring 236 sufficiently enough to elevate the temperature of the spacer ring 236 to the melting temperature of the disc portion ring 222.

The integrated brake rotors 10, 110, 210 are more lightweight when compared to a cast iron brake rotor of a similar size. This is due to the difference in density between aluminum alloy and cast iron. Aluminum alloy is about ⅖^{ths} as dense as cast iron. The rotor bodies 14, 114, 214 are formed from aluminum alloy and comprises the bulk of the size of the integrated brake rotors 10, 110, 210. As a result, less energy is required to rotationally accelerate the brake rotors 10, 110, 210 which translates to an expected increase in fuel mileage for the associated overland vehicle.

The steel (or titanium) braking rings 30, 38, 230, 238 provide a harder, and more wear-resistant surface compared to the braking surface provided by the cast iron brake rotors. As a result, the service life of the integrated brake rotors 10, 110, 210 is expected to be longer than the service life of the conventional cast iron brake rotors.

Before concluding, it should be noted that while aluminum, aluminum foam, steel, and titanium have been mentioned, other materials may be substituted for these metals and generally substitutions resulting in similar strength, weight, heat dissipation, hardness, and other characteristic relationships may be used in embodiments of the invention

As can be seen from the above, in some embodiments the invention provides an improved brake rotor. Various features of embodiments of the invention are set forth in the following claims.

What is claimed is:

1. A brake rotor comprising:
a rotor body made of a first material, the rotor body including a disc portion having an inner disc surface and an outer disc surface, the rotor body also including a central hub portion coupled to the disc portion,
an inner braking ring made of a second material and positioned on the inner disc surface, the inner braking ring including at least one projection engaging the rotor body to maintain the inner braking ring in a fixed orientation relative to the inner disc surface; and
an outer braking ring made of the second material and positioned on the outer disc surface, the outer braking ring including at least one projection engaging the rotor body to maintain the outer braking ring in a fixed orientation relative to the outer disc surface.

2. The brake rotor of claim 1, wherein the first material has a higher thermal conductivity than the second material.

3. The brake rotor of claim 1, wherein the first material has a lower material density than the second material.

4. The brake rotor of claim 1, wherein the second material has a higher material hardness than the first material.

5. The brake rotor of claim 4, wherein the first material is aluminum alloy, and wherein the second material is one of the group of steel and titanium.

6. The brake rotor of claim 1, wherein the at least one projection on each of the inner and outer braking rings includes at least one hook, and wherein the at least one hook of the inner braking ring engages the inner disc surface and the at least one hook of the outer braking ring engages the outer disc surface.

7. The brake rotor of claim 6, wherein the inner braking ring defines an inner perimeter surface and an outer perimeter surface, and wherein at lease one hook extends from the inner perimeter surface and at least one hook extends from the outer perimeter surface.

8. The brake rotor of claim 7, wherein the outer braking ring defines an inner perimeter surface and an outer perimeter surface, and wherein at lease one hook extends from the outer perimeter surface.

9. The brake rotor of claim 6, wherein the at least one hook of the inner braking ring is at least partially embedded in the respective inner disc surface and the at least one hook of the outer braking ring is at least partially embedded in the outer disc surface.

10. The brake rotor of claim 1, wherein each of the inner and outer braking rings includes at least one tooth that engages the central hub portion.

11. The brake rotor of claim 10, wherein the at least one tooth has a dove tail shape.

12. The brake rotor of claim 11, wherein the at least one tooth of the inner braking ring is at least partially embedded in the inner disc surface and the at least one tooth of the outer braking ring is at least partially embedded in the outer disc surface.

13. The brake rotor of claim 1, further comprising cooling passages defined by the rotor body, wherein the cooling passages fluidly connect an interior portion of the rotor body with an exterior portion of the rotor body.

14. The brake rotor of claim 1, wherein the disc portion is made of a foamed aluminum alloy, and wherein the central hub portion is made of aluminum alloy.

15. The brake rotor of claim 1, further comprising a steel ring positioned in the rotor body, the steel ring separating the central hub portion and the disc portion.

16. The brake rotor of claim 1, wherein the disc portion defines an outer perimeter surface, and wherein the disc portion defines at least one notch in the outer perimeter surface.

17. The brake rotor of claim 16, wherein the inner braking ring defines an outer perimeter surface, wherein the at least one projection on the inner braking ring includes at least one finger, the finger extending from the outer perimeter surface to engage the at least one notch of the outer perimeter surface of the disc portion.

18. The brake rotor of claim 16, wherein the outer braking ring defines an outer perimeter surface, wherein the at least one projection on the outer braking ring includes at least one finger, the finger extending from the outer perimeter surface to engage the at least one notch of the outer perimeter surface of the disc portion.

19. A brake rotor, comprising:
a rotor body made of a first material, the rotor body including an inner disc surface and an outer disc surface;
an inner braking ring made of a second material and positioned on the inner disc surface, the inner braking ring including means for maintaining the inner braking ring in a fixed orientation relative to the inner disc surface; and
an outer braking ring made of the second material and positioned on the outer disc surface, the outer braking ring including means for maintaining the outer braking ring in a fixed orientation relative to the outer disc surface.

20. The brake rotor of claim 19, wherein the means for maintaining the inner braking ring in a fixed orientation relative to the inner disc surface includes at least one projection extending from the inner braking ring, and the means for maintaining the outer braking ring in a fixed orientation relative to the outer disc surface includes at least one projection extending from the outer braking ring.

21. The brake rotor of claim 20, wherein the at least one projection of the inner braking ring engages the rotor body, and wherein the at least one projection of the outer braking ring engages the rotor body.

22. The brake rotor of claim 20, wherein the inner braking ring defines an inner perimeter surface and an outer perimeter surface, and wherein at least one projection extends from the inner perimeter surface to engage the rotor body, and at least one projection extends from the outer perimeter surface to engage the rotor body.

23. The brake rotor of claim 22, wherein the at least one projection extending from the inner perimeter surface is one of a hook and a tooth.

24. The brake rotor of claim 22, wherein the at least one projection extending from the outer perimeter surface is a hook.

25. The brake rotor of claim 20, wherein the outer braking ring defines an inner perimeter surface and an outer perimeter surface, and wherein at least one projection extends from the inner perimeter surface to engage the rotor body, and at least one projection extends from the outer perimeter surface to engage the rotor body.

26. The brake rotor of claim 25, wherein the at least one projection extending from the inner perimeter surface is a tooth.

27. The brake rotor of claim 25, wherein the at least one projection extending from the outer perimeter surface is a hook.

28. The brake rotor of claim 20, wherein the at least one projection extending from the inner braking ring is at least partially embedded in the inner disc surface and the at least one projection extending from the outer braking ring is at least partially embedded in the outer disc surface.

29. The brake rotor of claim 19, further comprising cooling passages defined by the rotor body, wherein the cooling passages fluidly connect an interior portion of the rotor body with an exterior portion of the rotor body.

30. A method of manufacturing a brake rotor, the method comprising:
providing an inner braking ring made of a first material and including at least one projection extending therefrom;
providing an outer braking ring made of the first material and including at least one projection extending therefrom;
positioning the inner braking ring and outer braking ring in a facing relationship within a die;
filling the die with molten metal of a second material, wherein the die is shaped to form a brake rotor body;
guiding the molten metal substantially between the inner braking ring and outer braking ring, such that the molten metal at least partially engulfs the at least one projection of the inner braking ring and at least partially engulfs the at least one projection of the outer braking ring;
cooling the molten metal to a point of solidification, wherein the solidified molten metal forms the brake rotor body, and wherein the molten metal solidifies around the at least one projection of the inner braking ring and the at least one projection of the outer braking ring to form the brake rotor; and
removing the brake rotor from the die.

31. The method of claim 30, wherein providing an inner braking ring includes stamping the inner braking ring from sheet metal.

32. The method of claim 31, wherein the at least one projection of the inner braking ring is formed during stamping.

33. The method of claim 30, wherein providing an outer braking ring includes stamping the outer braking ring from sheet metal.

34. The method of claim 35, wherein the at least one projection of the outer braking ring is formed during stamping.

35. The method of claim 30, wherein providing an inner braking ring and outer braking ring made of a first material include the first material having a higher melting point than the second material.

36. The method of claim 35, wherein the first material is one of steel and titanium, and wherein the second material is aluminum alloy.

37. The method of claim 30, further comprising positioning a disc portion core ring between the inner and outer braking rings.

38. The method of claim 37, further comprising inserting a spacer ring inside the disc portion core ring.

39. A method of manufacturing a brake rotor, the method comprising:
positioning a first braking ring including a first projection extending therefrom within a die;
positioning a second braking ring including a second projection extending therefrom within the die and in facing relationship with the first braking ring;
filling the die with a molten metal;
guiding the molten metal to at least partially engulf the first and second projections;
cooling the molten metal; and
removing the brake rotor from the die.

40. The method of claim 39, further comprising positioning a disc portion core ring between the first and second braking rings.

41. The method of claim 40, further comprising inserting a spacer ring inside the disc portion core ring.

42. A brake rotor comprising:
a rotor body made of a first material, the rotor body including
a disc portion having an inner disc surface and outer disc surface,
a central hub portion coupled to the disc portion, and
a projection extending from the central hub portion;
an inner braking ring made of a second material and positioned on the inner disc surface, the inner braking ring including a recess engaging the projection of the rotor body to maintain the inner braking ring in a fixed orientation relative to the inner disc surface; and
an outer braking ring made of the second material and positioned on the outer disc surface, the outer braking ring including a recess engaging the projection of the rotor body to maintain the outer braking ring in a fixed orientation relative to the outer disc surface.

43. The brake rotor of claim 42, wherein the projection and the recesses have dove-tail shapes.

44. The brake rotor of claim 42, wherein the projection is at least partially embedded in the outer braking ring, and wherein the projection is at least partially embedded in the inner braking ring.
